(19) United States
(12) Patent Application Publication
(10) Pub. No.: US 2020/0132173 A1
(43) Pub. Date: Apr. 30, 2020

(54) Tensioner

(71) Applicant: GATES CORPORATION, Denver, CO (US)

(72) Inventors: Anthony R. Mora, Waterford, MI (US); Alexander Serkh, Troy, MI (US); Minchun Hao, Troy, MI (US); Keming Liu, Sterling Heights, MI (US); Andrzej Dec, Rochester Hills, MI (US)

(21) Appl. No.: 16/169,404

(22) Filed: Oct. 24, 2018

(51) Int. Cl. F16H 7/12

(52) U.S. Cl. CPC F16H 7/1218; F16H 2007/0806

(57) ABSTRACT

A tensioner comprising a bracket, a first swing arm pivotally mounted to the bracket, a first pulley journalled to the first swing arm, a second swing arm pivotally mounted to the bracket, a second pulley journalled to the second swing arm, and a damping member connected between the first swing arm and the second swing arm, the damping member having a asymmetric damping characteristic.

### FIELD OF THE INVENTION

The invention relates to a tensioner, and more particularly, to a tensioner having a first swing arm and a second swing arm connected to a bracket, a damping strut having an asymmetric damping characteristic connected between the first swing arm and the second swing arm.

### BACKGROUND OF THE INVENTION

Most internal combustion engines comprise accessories such as power steering, an alternator and air conditioning to name a few. These accessories are typically driven by a belt. A tensioner is typically used to apply a preload to the belt in order to prevent slippage. The tensioner can be mounted to an engine mounting surface.

The engine may further comprise a start-stop system whereby the engine will shut down when the vehicle is not in motion, and when a driver command is received to proceed the engine will restart, usually by action of a motor-generator unit (MGU).

The start-stop function will tend to reverse loading on the belt. Hence, tensioners are available to accommodate belt load reversals. The tensioner may comprise one or more components which independently pivot in order to properly apply a required belt preload force in both belt drive directions. The tensioner may also be mounted directly to an accessory such as the MGU in order to save space in the engine bay.

Representative of the art is U.S. Pat. No. 9,795,293 which discloses a tensioner for tensioning a belt and includes first and second tensioner arms having first and second pulleys respectively. The first and second pulleys are configured for engagement with first and second belt spans, and are biased in first and second free arm directions respectively. A second tensioner arm stop is positioned to limit the movement of the second tensioner arm in a direction opposite the second free arm direction. The second tensioner arm stop is positioned such that, in use, the second pulley is engaged with the endless drive member while the second tensioner arm is engaged with the second tensioner arm stop throughout a first selected range of operating conditions.

What is needed is a tensioner having a first swing arm and a second swing arm connected to a bracket, a damping strut having an asymmetric damping characteristic connected between the first swing arm and the second swing arm.

### SUMMARY OF THE INVENTION

The primary aspect of the invention is to provide a tensioner having a first swing arm and a second swing arm connected to a bracket, a damping strut having an asymmetric damping characteristic connected between the first swing arm and the second swing arm.

Other aspects of the invention will be pointed out or made obvious by the following description of the invention and the accompanying drawings.

The invention comprises a tensioner comprising a bracket, a first swing arm pivotally mounted to the bracket, a first pulley journalled to the first swing arm, a second swing arm pivotally mounted to the bracket, a second pulley journalled to the second swing arm, and a damping member connected between the first swing arm and the second swing arm, the damping member having a asymmetric damping characteristic.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tensioner.

FIG. 2 is an exploded view of the damping strut.

FIG. 3A is a detail of the damping wedge.

FIG. 3B is a detail of the damping wedge.

FIG. 4 is a cross-section of the assembled strut.

FIG. 5 is an exploded view of the tensioner arms.

FIG. 6 is a partial cross section of the assembled tensioner without the strut.

FIG. 7 is a partial cross section of the assembled tensioner with the strut.

FIG. 8 is a rear perspective of the tensioner.

FIG. 9 is a schematic view of an engine MGU system incorporating the tensioner.

FIG. 10 is a free body diagram of the damping wedges during loading.

FIG. 11 is a free body diagram of the damping wedges during unloading.

FIG. 12 is a cross section of the tensioner using multiple damping wedges.

FIG. 13 is an alternate embodiment comprising multiple damping struts.

### DETAILED DESCRIPTION OF THE PREFERRED EMBODIMENT

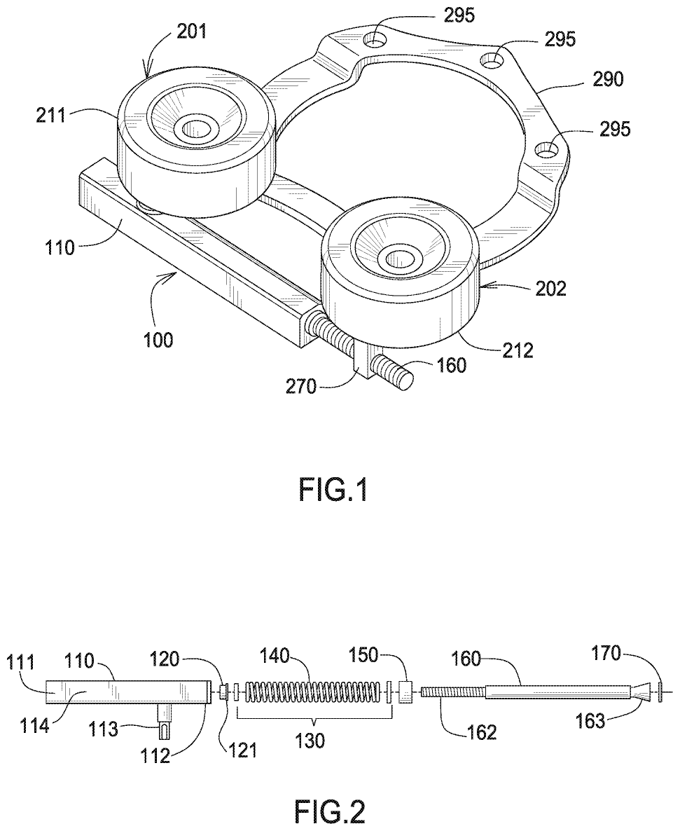

FIG. 1 is a perspective view of the tensioner. The tensioner comprises two tensioner sub-assemblies 201, 202 linked together by a mechanical strut sub-assembly 100. The sub-assemblies 201, 202 are pivotally mounted to an arcuate bracket 290.

FIG. 2 is an exploded view of the damping strut.

Strut bushing 120 is press fit into an end of strut cylinder 110 so that flange 121 of bushing 120 engages inner diameter 111 of cylinder 110. The strut's inner components are assembled around rod 160. Spring supports 130 and spring 140 slide onto rod 160.

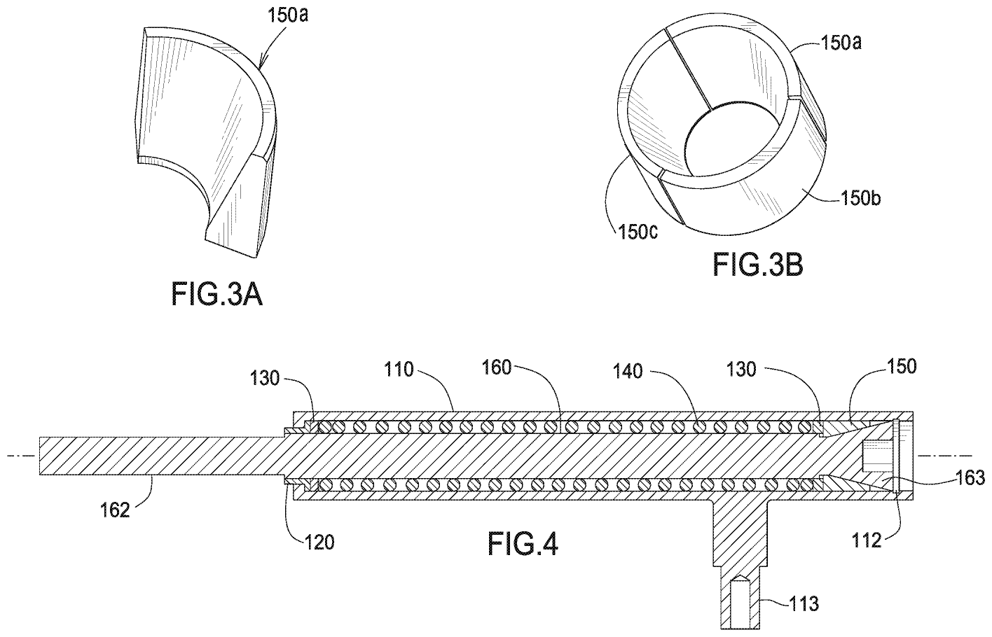

FIG. 3A is a detail of the damping wedge. FIG. 3B is a detail of the damping wedge. The damping wedge 150 comprises three segments. Wedge 150 is assembled in a circle around the frustoconical portion 163 of rod 160 adjacent to a support 130. These components are installed within strut cylinder 110, and are held in place by a snap ring 170 which is fitted into a groove 112. The wedge member comprises three segments in order to facilitate radial expansion of the wedge member as it is pressed against portion 163.

FIG. 4 is a cross-section of the assembled strut.

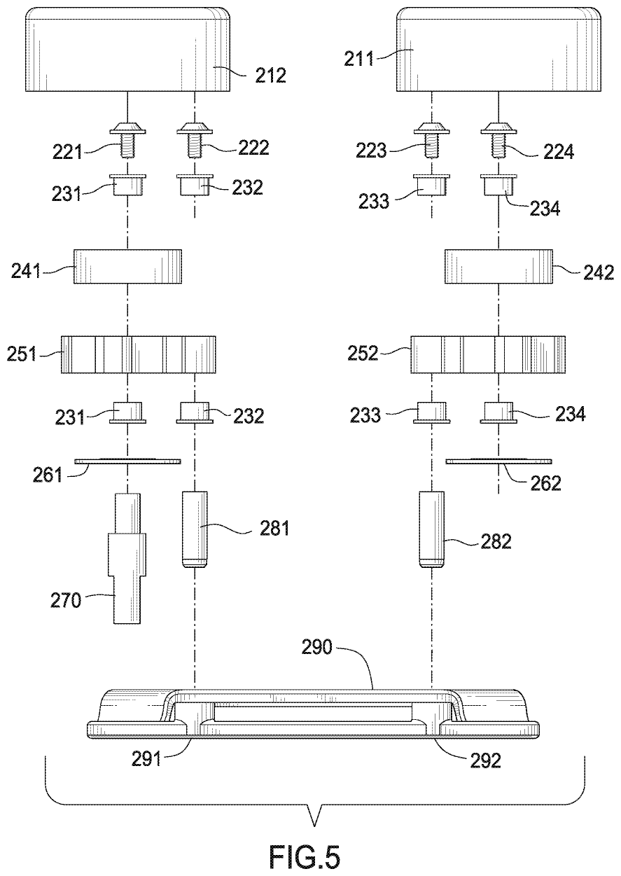

FIG. 5 is an exploded view of the tensioner arms. Tensioner sub-assemblies 201, 202 are identical except for the strut attachment parts. The sub-assemblies are pivotally mounted to bracket 290. Bushings 231, 232, 233, 234, are pressed into each arm 251, 252. Each bearing 241, 242, is pressed into each arm 251, 252 respectively. Dowel pins 281, 282 are pressed into holes 291, 292 respectively in mounting bracket 290. Screw 222 engages dowel 281 to retain arm 251. Screw 223 engages dowel 282 to retain arm 252. Arm 251 pivots about dowel 281. Arm 252 pivots about dowel 282. Strut rod support 270 is secured in arm 251 with screw 221.

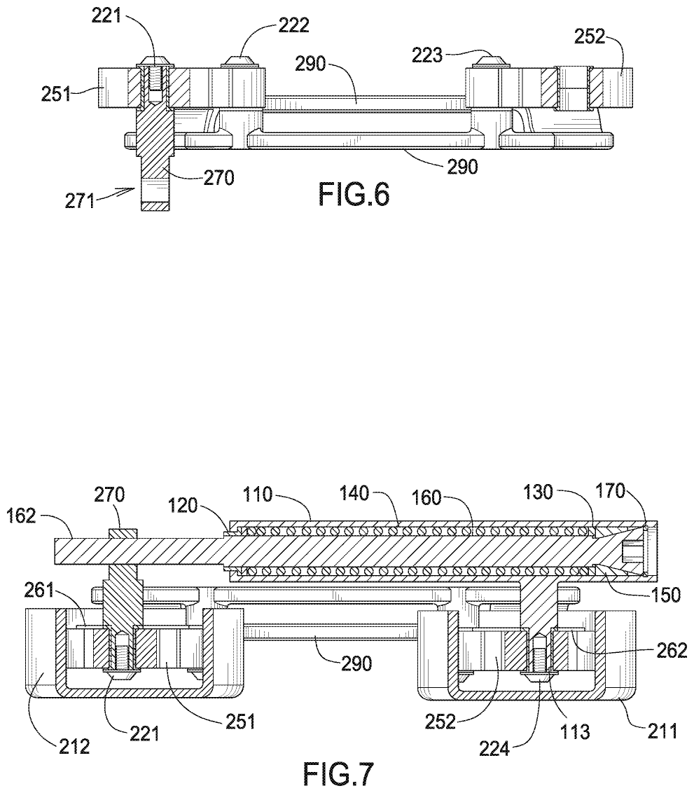

FIG. 6 is a partial cross section of the assembled tensioner without the strut.

FIG. 7 is a partial cross section of the assembled tensioner with the strut. Mounting post 113 of cylinder 110 is inserted into arm 252 and secured with screw 224. Threaded portion 162 of rod 160 is screwed into the threaded hole 271 of rod support 270. Threaded portion 162 allows adjustment of the relative position of arm 251 with respect to arm 252.

Bearings 241, 242 are pressed onto the hub of each pulley 211, 212 respectively, until each bearing bottoms out. Pulleys 211, 212 rotate with the inner raceway of the bearings. Dust caps 261, 262, are pressed onto the hub of each pulley 211, 212 respectively.

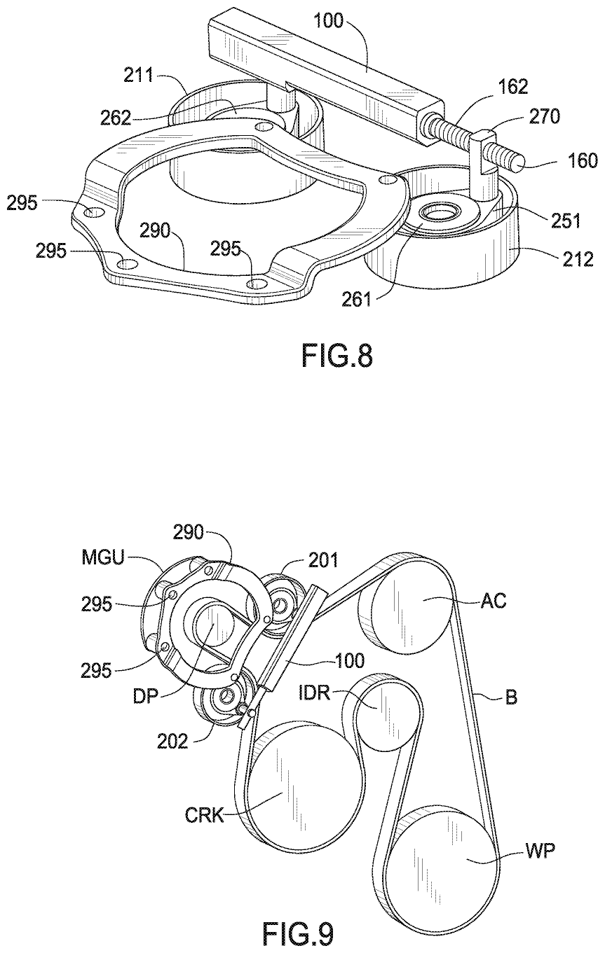

FIG. 8 is a rear perspective of the tensioner. Holes 295 are used for fasteners to mount the tensioner to an MGU, see FIG. 9.

FIG. 9 is a schematic view of an engine MGU system incorporating the tensioner. The tensioner is mounted to an MGU. The MGU comprises a driver pulley DP. A serpentine belt B is routed to the air conditioner compressor AC, water pump WP and crankshaft CRK. The MGU serves as both a driving motor for engine starts and accessory operation, and as an alternator driven by the engine to provide electrical power to the vehicle.

In normal mode crankshaft CRK is driving belt B. Belt B in turn drives the MGU pulley DP. In stop-start mode the MGU drives pulley DP which in turn drives belt B to drive crankshaft CRK, thereby starting the engine (not shown).

Bracket 290 has an arcuate form that encircles the driven pulley DP. Each tensioner sub-assembly 201, 202 is disposed opposite the other on bracket 290. Each sub-assembly pulley 211, 212 is coplanar with the other and with the driven pulley DP. Driven pulley DP projects within bracket 290. Bracket 290 is mountable to a driven device in surrounding relationship with a shaft of the driven device. Driven pulley DP is mounted to the shaft.

### Dynamic Description

In order to increase fuel economy and efficiency, many automotive manufacturers are incorporating alternators with the capability to drive the accessory belt drive system (ABDS). Such alternators are commonly referred to motor generator units (MGU's) or belt starter generators (BSG's). These can be used to start the engine, charge the battery, and boost the vehicle.

During standard operation, the crank pulley drives the ABDS system. When this is the case, the tight side is the side of the belt that is entering the crank pulley, and the slack side is the side that is coming off of the crank pulley. However, when the MGU is used to drive the system (such as during starting), the tight side becomes the side of the belt entering the MGU, and the slack side is the side of the belt leaving the MGU. This is the opposite of the former situation when driven by the crank pulley.

The slack side of the belt is the side that requires a tensioner. Since the slack side of the belt changes during different modes of operation, a tensioner that can adapt to these changing conditions is needed in order to properly control belt tension.

The inventive tensioner controls belt tension on both sides in order to respond to the alternating belt slack side. It comprises two separate tensioners coupled by a mechanical damping strut.

As torque output by the driving pulley grows so does belt tension. The increase in belt tension tends to push the tensioner pulley on the belt tight side away from the belt path. Since the pulleys are linked by the strut, the tensioner pulley on the slack side is pulled into the belt path as the tight side pulley is pushed away. Since the strut can change length by elongating and contracting this motion does not occur in a 1:1 fashion between the two tensioners, that is, there is relative motion between the two tensioner pulleys 211, 212.

For example, if the tight side pulley moves 20°, the slack side might move 10°, while actual values may depend on drive geometry and other factors. Therefore, an increase in belt tension will tend to separate the tensioner pulleys relative to one another. As the pulleys move apart, the strut rod follows one pulley, and the spring and cylinder follow the other. This causes the spring to compress and the load in the spring to increase. The increasing spring load along with increasing rod/cylinder separation causes the damping wedges 150 to slide up the frustoconical portion 163 of the rod.

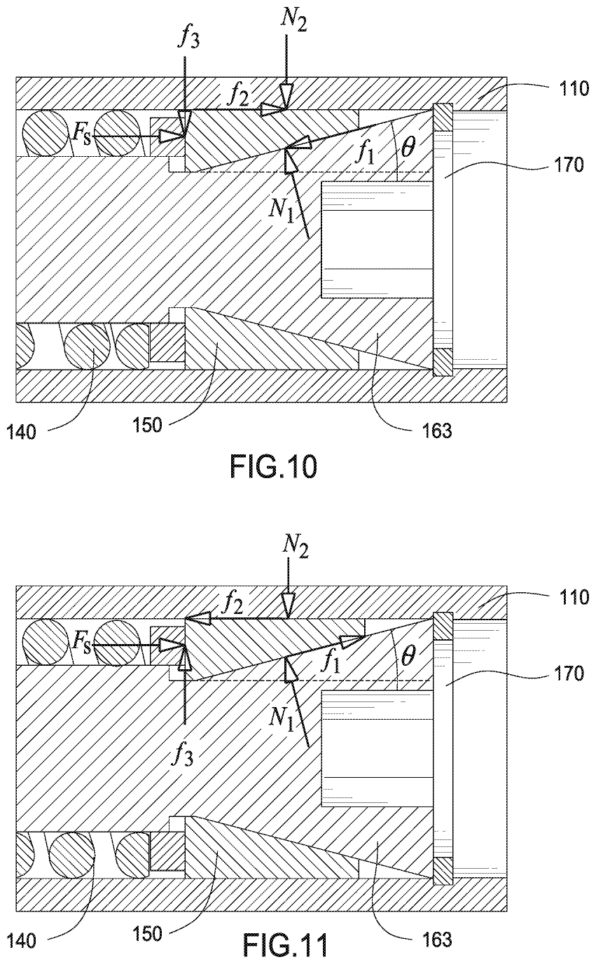

FIG. 10 is a free body diagram of the damping wedges during loading.

FIG. 11 is a free body diagram of the damping wedges during unloading. As wedges 150 slide on portion 163 they are urged radially outward and come into contact with the inner surface 114 of the strut cylinder. Once in contact with the inner surface, the wedges exhibit frictional damping on three surfaces: spring support 130, frustoconical portion 163, and inner surface 114.

The frictional forces are denoted f₁, f₂, and f₃. They are products of the two normal forces N₁N₂, and the spring force Fₛ respectively. Frictional force f₂ is responsible for the majority of the damping, the other contributions are negligibly small. This is because the majority of the movement occurs between inner surface 114 and damping wedge 150, with the other two either not moving at all or barely moving. The movement causes energy to be dissipated as heat, thus damping the system. The magnitude of the spring force along with the angle of the frustoconical portion of the rod θ influences the magnitude of N₁, which governs the magnitude of N₂, which governs the magnitude of f₂ according to the relationship f₂=μ₂N₂ where μ₂ is the coefficient of friction between the wedges and the cylinder bore. When moving in the loading direction, f₂ is in the same direction as the spring force Fₛ and therefore is additive; that is, it works to increase tension in the damping strut beyond just the spring force.

On the other hand, as the torque output of the driving pulley decreases so does the belt tension. This causes the tensioner pulleys to move toward one another. The pulleys moving toward one another result in rod 160 plunging deeper into cylinder 110. This movement acts to decrease the load in spring 140.

When movement is in the unloading direction, the amount of wedging between wedge 150 and cylinder inner surface 114 reduces, and all of the frictional forces reverse direction as shown in FIG. 11. During unloading, the primary damping force f₂ opposes the spring force Fₛ, which works to reduce tension in the strut. Due to decreased wedging and lower spring loads, damping is much less in the unloading direction. The phenomenon of different levels of damping depending on the direction of movement is known as asymmetric damping. Asymmetric damping is advantageous in the case of a tensioner as it provides greater resistance when it is needed, and less resistance when it is not.

In an alternate embodiment the noted parameters of the device can be adjusted such that the frictional forces are substantially equivalent in both movement directions resulting in symmetric damping. Either asymmetric or symmetric damping can be used as required.

When the belt is being loaded by the driving pulley(s), belt tension is increased above a nominal level. This tends to reduce the probability of belt slip, dampens system vibrations, and reduces impulse magnitudes. Not only is this preferable for system performance, it is also advantageous to tensioner life—less violent movement equates to less wear.

When the driving pulleys in the system reduce torque and/or speed, the belt tension drops below the nominal value. During unloading, there is little to no probability of belt slip, so there is no reason to have the belt at the nominal tension. Allowing the belt to unload at lower than nominal tensions results in longer belt life than would occur without asymmetric damping.

While the damping in this system asymmetric, it is tunable as well. As noted, the magnitude of angle θ controls the magnitude of normal force N₁ which in turn controls the magnitude of N₂ and consequently f₂, the primary damping force. Therefore, changing angle θ changes the amount of damping produced. Furthermore, alternate embodiments of the design can include multiple sets of wedges. In this way the amount of damping exhibited can be altered.

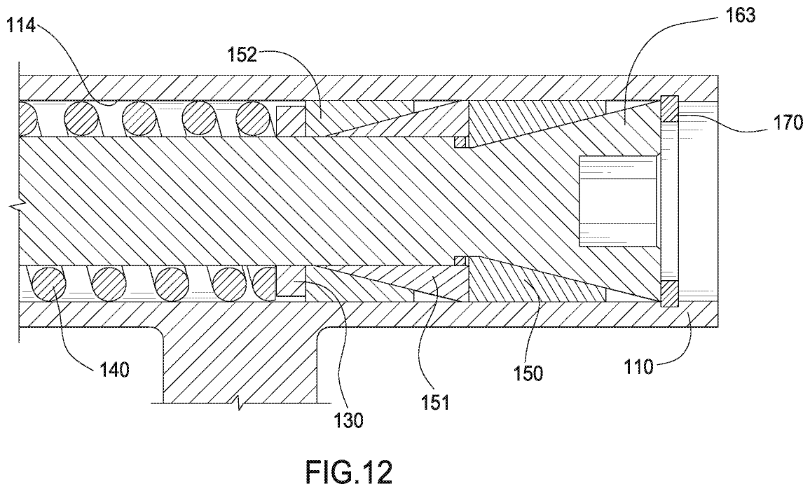

FIG. 12 is a cross section of the tensioner using multiple damping wedges. In the case of multiple sets of wedges, there is a requirement to add a spacer cone 151 for each set of additional wedges 152. While the wedges are made of an internally lubricated polymer, the spacer cone is composed of steel as is rod 160. If the same steel is chosen for the rod as for the spacer, then the coefficient of friction between the additional wedges and spacers is the same, different steel can be selected to alter this coefficient, thus further adjusting the damping exhibited. The coefficients of friction can be further varied by varying the surface finish of spacer 151, and/or frustoconical portion 163 of the rod, and/or inner surface 114.

The mechanics behind multiple sets of wedges are similar to those of a single set system; however there are more steps involved. When multiple sets of wedges are introduced, both the number of frictional surfaces (and consequently frictional forces) increases, as well as the amount of frictional surface area. This increase in these two parameters leads to an increase in frictional damping. It is important to note that other alternate embodiments are not limited to a maximum of two sets of wedges as depicted in FIG. 12—more sets of wedges can be added as needed to produce the desired amount of damping.

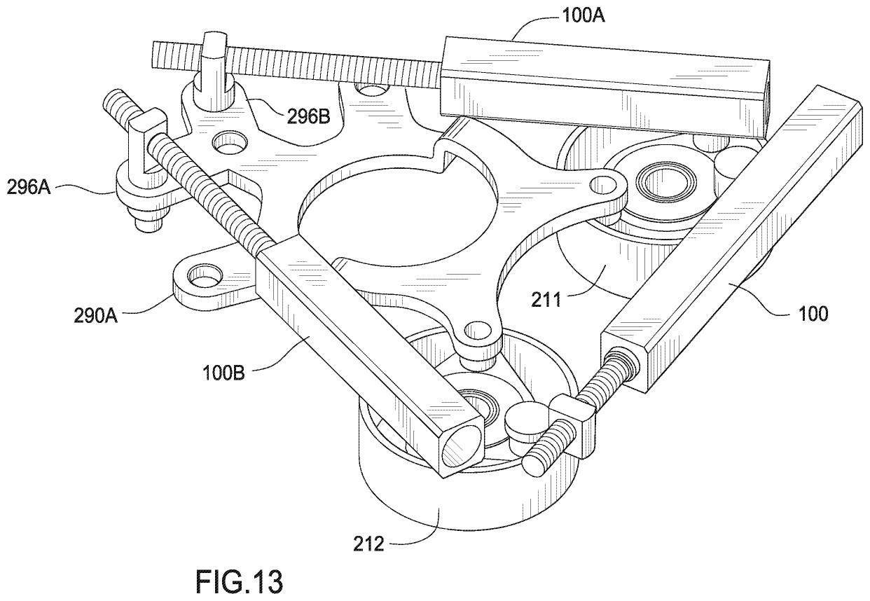

FIG. 13 is an alternate embodiment comprising multiple damping struts. In an alternate embodiment a second damping strut 100A is engaged between bracket 290A and either of swing arm 251 or 252 such that the given swing arm has two damping struts attached to it. In yet another embodiment a third damping strut 100B is engaged between bracket 290 and either of swing arm 251 or swing arm 252 (whichever does not have 100A attached to it) such that each swing arm has two damping struts attached to it; thereby resulting in three damping struts in use on the tensioner. This further enhances the damping effect of each swing arm when compared to a single damping strut. Damping strut 100A is attached to bracket 290 at hole 296A and damping strut 100B is attached to bracket 290 at hole 296B.

In yet another embodiment, hydraulic or gas damping struts can be substituted for the wedge type struts described herein. Hydraulic damping struts and gas type damping struts are known in the damping arts.

Further, either symmetric or asymmetric damping can be applied to each of the struts in this embodiment. The configuration as to which dampers are symmetric or asymmetric can be varied to achieve a desired system response or characteristic.

A tensioner comprising a bracket mountable to a driven device in surrounding relationship with a shaft of the driven device, a first swing arm pivotally mounted to the bracket, a first pulley journalled to the first swing arm, a second swing arm pivotally mounted to the bracket, a second pulley journalled to the second swing arm, a damping strut member connected between the first swing arm and the second swing arm, the damping member having an asymmetric damping characteristic, and the damping strut member comprises a body and a cooperating rod, a first wedge member fictionally disposed between a frustoconical portion of the rod and a body inner surface, and a spring urging the first wedge member into frictional engagement with the frustoconical portion and the body inner surface.

Although forms of the invention have been described herein, it will be obvious to those skilled in the art that variations may be made in the construction and relation of parts without departing from the spirit and scope of the invention described herein. Unless otherwise specifically noted, components depicted in the drawings are not drawn to scale. Further, it is not intended that any of the appended claims or claim elements invoke 35 U.S.C. 112(f) unless the words “means for” or “step for” are explicitly used in the particular claim. The present disclosure should in no way be limited to the exemplary embodiments or numerical dimensions illustrated in the drawings and described herein.

We claim:

1. A tensioner comprising:
a bracket;
a first swing arm pivotally mounted to the bracket, a first pulley journalled to the first swing arm;
a second swing arm pivotally mounted to the bracket, a second pulley journalled to the second swing arm; and
a damping strut member connected between the first swing arm and the second swing arm, the damping member having a damping characteristic.

2. The tensioner as in claim 1, wherein the damping strut member further comprises:
a cylinder and a cooperating rod, a wedge member fictionally disposed between a frustoconical portion of the rod and a cylinder inner surface, and, a spring urging the wedge member into pressing engagement with the frustoconical portion and the cylinder inner surface; and
an asymmetric damping characteristic.

3. The tensioner as in claim 2, wherein the rod further comprises a threaded portion to which the first swing arm is threadably connected.

4. The tensioner as in claim 1, wherein the bracket comprises an arcuate form that encircles a driven pulley.

5. A tensioner comprising:
a bracket;
a first swing arm pivotally mounted to the bracket, a first pulley journalled to the first swing arm;
a second swing arm pivotally mounted to the bracket, a second pulley journalled to the second swing arm;
a damping strut member connected between the first swing arm and the second swing arm, the damping member having an asymmetric damping characteristic; and
the damping strut member comprises a body and a cooperating rod, a wedge member fictionally disposed between a frustoconical portion of the rod and a body inner surface, and a spring urging the wedge member into frictional engagement with the frustoconical portion and the body inner surface.

6. The tensioner as in claim 5, wherein the bracket is mountable to a driven device in surrounding relationship with a shaft of the driven device.

7. A tensioner comprising:
a bracket mountable to a driven device in surrounding relationship with a shaft of the driven device;
a first swing arm pivotally mounted to the bracket, a first pulley journalled to the first swing arm;
a second swing arm pivotally mounted to the bracket, a second pulley journalled to the second swing arm;
a first damping strut member connected between the first swing arm and the second swing arm, the first damping strut member having a damping characteristic; and
the first damping strut member comprises a body and a cooperating rod, a first wedge member fictionally disposed between a frustoconical portion of the rod and a body inner surface, and a spring urging the first wedge member into frictional engagement with the frustoconical portion and the body inner surface.

8. The tensioner as in claim 7, wherein the body is cylindrical.

9. The tensioner as in claim 7, wherein the first wedge member comprises two or more segments.

10. The tensioner as in claim 7, wherein the driven device comprises a motor generator unit.

11. The tensioner as in claim 7, wherein the rod comprises a threaded portion disposed distally to the frustoconical portion.

12. The tensioner as in claim 7 further comprising a second wedge member in cooperating engagement with the first wedge member.

13. The tensioner as in claim 7 further comprising a second damping strut member engaged between the bracket and the first swing arm.

14. The tensioner as in claim 13 further comprising a third damping strut member engaged between the bracket and the second swing arm.

15. The tensioner as in claim 7, wherein the damping characteristic is asymmetric.

16. The tensioner as in claim 7, wherein the damping characteristic is symmetric.

17. The tensioner as in claim 13, wherein the second damping strut member comprises an asymmetric damping characteristic.

18. The tensioner as in claim 13, wherein the second damping strut member comprises a symmetric damping characteristic.

19. The tensioner as in claim 14, wherein the third damping strut member comprises an asymmetric damping characteristic.

20. The tensioner as in claim 13, wherein the third damping strut member comprises a symmetric damping characteristic.
